(19) United States
(12) Patent Application Publication
(10) Pub. No.: US 2025/0201026 A1
(43) Pub. Date: Jun. 19, 2025

(54) COOKING MOTION ESTIMATION DEVICE, COOKING MOTION ESTIMATION METHOD, AND COOKING MOTION ESTIMATION PROGRAM

(71) Applicant: AJINOMOTO CO., INC., Tokyo (JP)

(72) Inventors: Suguru MORI, Kanagawa (JP); Kyoko SUDO, Tokyo (JP); Hiroya KAWASAKI, Kanagawa (JP); Nobukazu ONO, Kanagawa (JP); Yuko MIYAKE, Kanagawa (JP)

(73) Assignee: AJINOMOTO CO., INC., Tokyo (JP)

(21) Appl. No.: 19/063,840

(22) Filed: Feb. 26, 2025

Related U.S. Application Data
(63) Continuation of application No. PCT/JP2023/031880, filed on Aug. 31, 2023.

(30) Foreign Application Priority Data
Sep. 1, 2022 (JP) 2022-139367

(51) Int. Cl. G06V 40/20; G06T 7/246; G06T 7/73; G06V 10/62; G06V 10/764; G06V 10/77; G06V 20/40; G06V 20/70

(52) U.S. Cl. CPC G06V 40/28; G06T 7/251; G06T 7/75; G06V 10/62; G06V 10/764; G06V 10/7715; G06V 20/41; G06V 20/70; G06T 2207/10016; G06T 2207/20081; G06T 2207/30196

(57) ABSTRACT

Coordinates of a joint point are identified, and a hand region that is a coordinate region of a hand is estimated, for each of video frames that constitute a cooking behavior video, based on posture recognition technology. A cooking utensil region that is a coordinate region of a cooking utensil is identified for each of the video frames that constitute the cooking behavior video, based on object recognition technology. When the hand region and the cooking utensil region overlap, a cooking motion for each of the video frames is estimated from a type of the cooking utensil.

### CROSS-REFERENCE TO RELATED APPLICATION

This application is based upon and claims the benefit of priority from PCT Application PCT/JP2023/031880, filed Aug. 31, 2023, which claims priority from Japanese Patent Application No. 2022-139367, filed Sep. 1, 2022, the entire contents of which are incorporated herein by reference.

### BACKGROUND OF THE INVENTION

### 1. Field of the Invention

The present invention relates to a cooking motion estimation device, a cooking motion estimation method, and a cooking motion estimation program.

### 2. Description of the Related Art

JP-A-2021-140711 discloses a technology for creating a recipe that captures the entire cooking process including cooking motions by taking images with a camera fixed to a range hood.

JP-B-6391078 discloses a technology for generating a short video suitable for viewing by customers at food sections of supermarkets and the like from a movie that captures cooking scenes.

JP-A-2020-135417 discloses a technology that can estimate the amount of food ingredients or seasonings used, using only a movie during cooking taken by a user from above with a camera.

JP-A-2005-284408 discloses a technology for recognizing the direction of line of sight based on the position of the user's eyeballs from a movie during cooking taken from the front using two cameras fixed in a kitchen, and estimating a work process based on the user's current position, body orientation, and line of sight.

However, the conventional inventions are unable to capture cooking motions by combining recognition of human motions using posture recognition technology with recognition of cooking utensils using object recognition technology.

### SUMMARY OF THE INVENTION

It is an object of the present invention to at least partially solve the problems in the conventional technology.

The present invention is made in view of the problem, and an object of the present invention is to provide a cooking motion estimation device, a cooking motion estimation method, and a cooking motion estimation program by which, when a region of a hand estimated from the coordinates of a joint point recognized by posture recognition for each video frame overlaps with a region of a cooking utensil recognized by object recognition, it can be determined that the cooking utensil is being used, and a cooking motion can be estimated from the type of the cooking utensil.

In order to solve the above problem and attain this object, a cooking motion estimation device according to one aspect of the present invention is a cooking motion estimation device comprising a storage unit and a control unit, wherein the storage unit includes a video storage unit that stores a cooking behavior video of each of users, and the control unit includes a hand estimating unit that identifies coordinates of a joint point and estimates a hand region that is a coordinate region of a hand, for each of video frames that constitute the cooking behavior video, based on posture recognition technology, a cooking utensil identifying unit that identifies a cooking utensil region that is a coordinate region of a cooking utensil, for each of the video frames that constitute the cooking behavior video, based on object recognition technology, and a cooking motion estimating unit that estimates a cooking motion for each of the video frames from a type of the cooking utensil when the hand region and the cooking utensil region overlap.

The cooking motion estimation device according to another aspect of the present invention is the cooking motion estimation device, wherein the control unit further includes a time setting unit that sets the video frames in connection with an elapsed time, and a classification calculating unit that calculates a cooking time and a workload for each cooking motion classification that distinguishes a feature of the cooking motion, based on the cooking motion for each of the video frames.

The cooking motion estimation device according to still another aspect of the present invention is the cooking motion estimation device, wherein the control unit further includes a representative value obtaining unit that obtains a cooking time representative value and a workload representative value for the each cooking motion classification, based on the cooking time and the workload for the each cooking motion classification of all of the users.

The cooking motion estimation device according to still another aspect of the present invention is the cooking motion estimation device, wherein the control unit further includes an outlier identifying unit that identifies the cooking behavior video in which the cooking motion with any one or both of the cooking time and the workload that are outliers is recorded, based on any one or both of the cooking time representative value and the workload representative value.

The cooking motion estimation device according to still another aspect of the present invention is the cooking motion estimation device, wherein the cooking behavior video is set in connection with attribute data indicating an attribute of the user, and the classification calculating unit calculates the cooking time and the workload for each attribute and for the each cooking motion classification, based on the attribute data and the cooking motion for each of the video frames.

The cooking motion estimation device according to still another aspect of the present invention is the cooking motion estimation device, wherein the time setting unit further obtains order data of the cooking motion, based on the cooking motion for each of the video frames, and the control unit further includes a cooking behavior obtaining unit that obtains cooking behavior data of the user, based on the cooking time and the workload for the each cooking motion classification, and the order data.

The cooking motion estimation device according to still another aspect of the present invention is the cooking motion estimation device, wherein the storage unit further includes a model storage unit that stores a posture recognition model in which hand video frames in which a plurality of hand movements during cooking are recorded are training data, the video frames that constitute the cooking behavior video are input, and the hand region is output, and the hand estimating unit identifies the coordinates of a joint point and estimates the hand region that is the coordinate region of a hand, for each of the video frames that constitute the cooking behavior video, using the posture recognition model.

The cooking motion estimation device according to still another aspect of the present invention is the cooking motion estimation device, wherein the storage unit further includes a model storage unit that stores an object recognition model in which cooking utensil video frames in which a plurality of the cooking utensils are recorded are training data, the video frames that constitute the cooking behavior video are input, and the cooking utensil region is output, and the cooking utensil identifying unit identifies the cooking utensil region that is the coordinate region of the cooking utensil, for each of the video frames that constitute the cooking behavior video, using the object recognition model.

The cooking motion estimation device according to still another aspect of the present invention is the cooking motion estimation device, wherein the attribute is a cooking proficiency level for distinguishing between being good at cooking and being poor at cooking.

The cooking motion estimation device according to still another aspect of the present invention is the cooking motion estimation device, wherein the cooking behavior video is a video that records cooking of each of the users from a side in any kitchen including a home kitchen of the user.

The cooking motion estimation device according to still another aspect of the present invention is the cooking motion estimation device, wherein the storage unit further includes a model storage unit that stores a cooking motion estimation model that is a machine learning model in which a cooking video labeled with the hand region is training data, the hand region and the cooking utensil region are explanatory variables, and the cooking motion is a response variable, and when the hand region and the cooking utensil region overlap, the cooking motion estimating unit estimates the cooking motion for each of the video frames from a type of the cooking utensil, using the cooking motion estimation model.

The cooking motion estimation device according to still another aspect of the present invention is the cooking motion estimation device, wherein the control unit further includes a food ingredient identifying unit that identifies a food ingredient region that is a coordinate region of a food ingredient, for each of the video frames that constitute the cooking behavior video, based on the object recognition technology or image segmentation technology for the video frames.

The cooking motion estimation device according to still another aspect of the present invention is the cooking motion estimation device, wherein the food ingredient identifying unit further estimates intake nutrients from the food ingredient.

The cooking motion estimation device according to still another aspect of the present invention is the cooking motion estimation device, wherein when the hand region and the food ingredient region overlap, or when the cooking utensil region and the food ingredient region overlap, the cooking motion estimating unit further estimates the cooking motion for each of the video frames from a type of the food ingredient.

The cooking motion estimation device according to still another aspect of the present invention is the cooking motion estimation device, wherein the control unit further includes a seasoning identifying unit that identifies a seasoning region that is a coordinate region of a seasoning, for each of the video frames that constitute the cooking behavior video, based on the object recognition technology.

The cooking motion estimation device according to still another aspect of the present invention is the cooking motion estimation device, wherein when the hand region and the seasoning region overlap, the cooking motion estimating unit further estimates the cooking motion for each of the video frames from a type of the seasoning.

A cooking motion estimation method according to still another aspect of the present invention is a cooking motion estimation method executed by a cooking motion estimation device including a storage unit and a control unit, wherein the storage unit includes a video storage unit that stores a cooking behavior video of each of users, the cooking motion estimation method executed by the control unit comprising a hand estimating step of identifying coordinates of a joint point and estimating a hand region that is a coordinate region of a hand, for each of video frames that constitute the cooking behavior video, based on posture recognition technology, a cooking utensil identifying step of identifying a cooking utensil region that is a coordinate region of a cooking utensil, for each of the video frames that constitute the cooking behavior video, based on object recognition technology, and a cooking motion estimating step of, when the hand region and the cooking utensil region overlap, estimating a cooking motion for each of the video frames from a type of the cooking utensil.

A cooking motion estimation program according to still another aspect of the present invention is a cooking motion estimation program executed by a cooking motion estimation device including a storage unit and a control unit, wherein the storage unit includes a video storage unit that stores a cooking behavior video of each of users, the cooking motion estimation program causing the control unit to execute a hand estimating step of identifying coordinates of a joint point and estimating a hand region that is a coordinate region of a hand, for each of video frames that constitute the cooking behavior video, based on posture recognition technology, a cooking utensil identifying step of identifying a cooking utensil region that is a coordinate region of a cooking utensil, for each of the video frames that constitute the cooking behavior video, based on object recognition technology, and a cooking motion estimating step of, when the hand region and the cooking utensil region overlap, estimating a cooking motion for each of the video frames from a type of the cooking utensil.

According to the present invention, indicators that are not dependent on the observer's subjectivity are introduced in observation of cooking behavior, and the time and effort for behavior observation is reduced, thereby implementing surveys targeting a large number of consumers. According to the present invention, behavior videos can be taken by consumers themselves using their own terminals such as smartphones, thereby eliminating the need for special filming equipment or for observers to visit consumers' home. According to the present invention, objective and quantitative indicators of consumers' cooking behavior can be provided from cooking videos taken by consumers. According to the present invention, the time and the workload for each cooking motion classification can be quantitatively evaluated, so that motions during cooking that users find burdensome can be extracted, and users performing characteristic behavior can be identified. According to the present invention, videos taken from the side rather than from above are used, so that, for example, the vertical movement of a hand when cutting food with a knife can be captured properly. As a result, according to the present invention, a workload for each cooking motion (process) can be estimated properly. According to the present invention, when a coordinate region of a hand estimated from the coordinates of a joint point recognized by posture recognition for each video frame overlaps with a region of a cooking utensil recognized by object recognition, it can be determined that the cooking utensil is being used, and a cooking motion can be estimated from the type of the cooking utensil being used. According to the present invention, the posture of a person in each frame of the video is recognized and the coordinates of each joint point are extracted from cooking video data captured by consumers themselves, a cooking utensil in each frame of the video is recognized and the type and coordinates of the cooking utensil are extracted, a cooking process is classified based on the extracted joint point data and cooking utensil data for each frame, and cooking behavior data such as the time, order, and workload of the classified cooking process can be created.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an example of a configuration of a cooking motion estimation device according to an embodiment of the present invention;

FIG. 2 is a flowchart of an example of a cooking motion estimation process according to the embodiment;

FIG. 3 is a diagram of an example of the cooking motion estimation process according to the embodiment;

FIG. 4 is a diagram of an example of the cooking motion estimation process according to the embodiment;

FIG. 5 is a diagram of an example of the cooking motion estimation process according to the embodiment;

FIG. 6 is a diagram of an example of the cooking motion estimation process according to the embodiment;

FIG. 7 is a diagram of an example of the cooking motion estimation process according to the embodiment;

FIG. 8 is a diagram of an example of a cooking behavior analysis result according to the embodiment;

FIG. 9 is a diagram of an example of a cooking behavior analysis result according to the embodiment;

FIG. 10 is a diagram of an example of a cooking behavior analysis result according to the embodiment;

FIG. 11 is a diagram of an example of image segmentation according to the embodiment; and

FIG. 12 is a diagram of an example of a cooking behavior analysis process according to the embodiment.

### DETAILED DESCRIPTION OF THE PREFERRED EMBODIMENTS

An embodiment of the present invention will be explained in detail based on the drawings. The present invention is not intended to be limited by the present embodiment.

### 1. Overview

First, an overview of the present invention will be explained.

When consumers' cooking experiences are surveyed, a method that observes consumers' behaviors is used. However, the behavior observation survey is significantly affected by observer's subjectivity. Usually, some ingenuity and effort that prevents extraction of only biased results is necessary, such as having multiple people observe behavior videos after taking the videos. On the other hand, to provide products and services that meet the rapidly changing consumer needs, it is necessary to quickly survey a diverse range of consumers.

In a conventional behavior observation method, visual behavior observation is conducted through central location test or visit survey to identify issues with cooking methods and develop new cooking directions. This method, however, involves a heavy workload, which makes it difficult to survey a large number of people, and enables only qualitative analysis.

The present embodiment provides a mechanism that reduces a workload, enables a survey of a large number of people, and enables quantitative analysis by obtaining cooking behavior data by automating behavior observation using artificial intelligence (AI) at subjects' home.

### 2. Configuration of Cooking Motion Estimation System

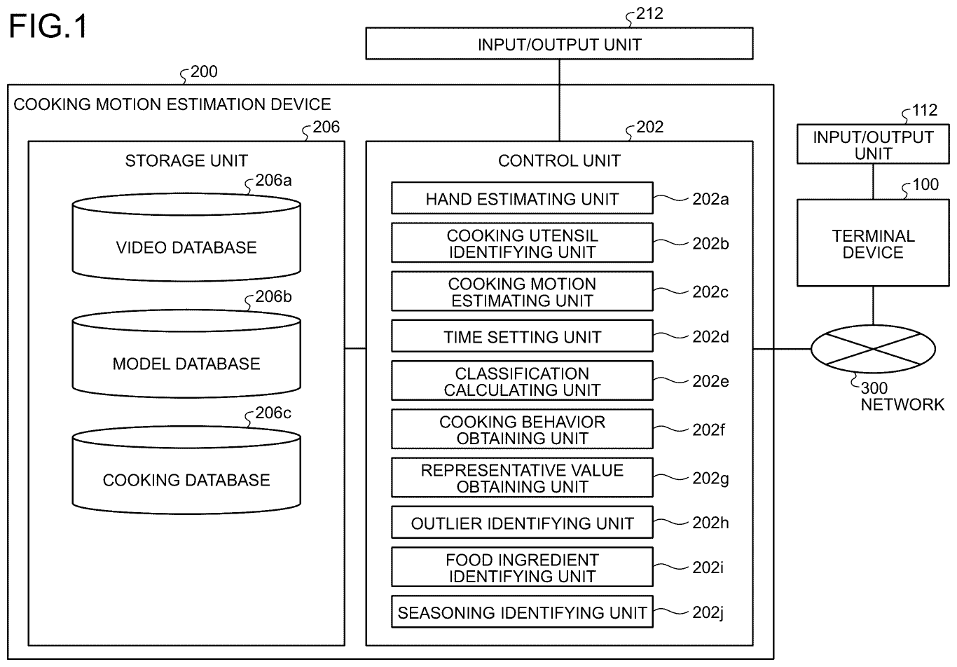

A cooking motion estimation system according to the present embodiment can be functionally or physically distributed or integrated in any units (in either a stand-alone configuration or a system configuration). According to the present embodiment, an example of a configuration of the cooking motion estimation system in which a terminal device 100 and a cooking motion estimation device 200 are communicatively connected will be explained with reference to FIG. 1. FIG. 1 is a block diagram of an example of a configuration of the cooking motion estimation device 200 according to the present embodiment.

### Configuration of Terminal Device 100

In FIG. 1, the terminal device 100 may be an information processing device such as a digital camera or a webcam, a mobile terminal such as a mobile phone, a smartphone, a tablet terminal, a PHS or a personal digital assistant (PDA), or a commercially available common desktop or laptop personal computer.

The terminal device 100 includes a control unit 102, a storage unit 106, and an input/output unit 112. The units included in the terminal device 100 are communicatively connected via any given communication channel.

The input/output unit 112 has the function of performing input/output (I/O) of data including videos, and is an image input unit (for example, camera) that records images (still images and moving images) captured by an imaging device such as a CCD image sensor or a CMOS image sensor as digital data. The input/output unit 112 may include, for example, a key input unit, a touch panel, a control pad (for example, touch pad and gamepad), a mouse, a keyboard, and a microphone. The input/output unit 112 may include a display unit (for example, display, monitor, and touch panel of liquid crystal or organic EL) that displays (input/output) information such as application software. The input/output unit 112 may include an audio output unit (for example, speaker) that outputs audio information as sound. The input/output unit 112 may include any one, some, or all of a fingerprint sensor, a camera (for example, infrared camera) that can be used for iris recognition or face recognition or the like, and a biometric sensor such as a vein sensor.

The terminal device 100 is communicatively connected to other devices via a network 300 and has the function of communicating data with other devices. The network 300 has the function of communicatively connecting the terminal device 100 and other devices to each other. The network 300 is, for example, any one or both of the Internet and a local area network (LAN).

The storage unit 106 stores any one, some, or all of various databases, tables, files, and the like. The storage unit 106 stores a computer program for giving instructions to a central processing unit (CPU) to perform various processing in cooperation with an operating system (OS). For example, any one, some, or all of a random access memory (RAM), a read only memory (ROM), a hard disk drive (HDD), a solid state drive (SSD), and the like can be used as the storage unit 106. The storage unit 106 may store any one, some, or all of image data recorded by the input/output unit 112, data received via the network 300, input data input via the input/output unit 112, and the like.

The control unit 102 is a CPU or the like that overall controls the terminal device 100. The control unit 102 has an internal memory for storing a control program such as an OS, a computer program that defines various processing procedures, required data, and the like, and executes various information processing based on these stored programs. For example, the control unit 102 may execute processing such as obtaining image data recorded by the input/output unit 112 and reading data such as text data (URL and the like) contained in the image data, transmitting and receiving data via the network 300, obtaining input data input via the input/output unit 112, and displaying data (screen) on the input/output unit 112.

### Configuration of Cooking Motion Estimation Device 200

In FIG. 1, the cooking motion estimation device 200 may be an information processing device such as a personal computer or a workstation. The cooking motion estimation device 200 includes a control unit 202, a storage unit 206, and an input/output unit 212. The units included in the cooking motion estimation device 200 are communicatively connected via any given communication channel. The cooking motion estimation device 200 and other devices are communicatively connected to each other via the network 300.

The input/output unit 212 may have the function of performing data input/output (I/O). The input/output unit 212 may be, for example, a key input unit, a touch panel, a control pad (for example, touch pad and gamepad), a mouse, a keyboard, and a microphone. The input/output unit 212 may be a display unit (for example, display, monitor, and touch panel of liquid crystal or organic EL) that displays (input/output) information such as application software. The input/output unit 212 may be an audio output unit (for example, speaker) that outputs audio information as sound. The input/output unit 212 may be an image input unit (for example, camera) that records images (still images and moving images) captured by an imaging device such as a CCD image sensor or a CMOS image sensor as digital data. The input/output unit 212 may be any one, some, or all of a fingerprint sensor, a camera (for example, infrared camera) that can be used for iris recognition or face recognition or the like, and a biometric sensor such as a vein sensor.

The storage unit 206 stores any one, some, or all of various databases, tables, files, and the like. A computer program for giving instructions to a CPU to perform various processing in cooperation with an OS is recorded in the storage unit 206. The storage unit 206 is a storage means such as any one, some, or all of a RAM, a ROM, an HDD, and an SSD and stores various databases and tables. The storage unit 206 functionally and conceptually includes a video database 206a, a model database 206b, and a cooking database 206c.

The video database 206a stores a video. The video database 206a may store a cooking behavior video of each of users. The cooking behavior video may be set in connection with attribute data indicating an attribute of the user. The attribute may be any one, some, or all of cooking proficiency level for distinguishing between being good at cooking and being poor at cooking, age, gender, presence or absence of various cooking skills, presence or absence of experience of using a product, cooking behavior characteristics (for example, stir-frying vegetables in a batch or stir-frying vegetables in two batches), response tendencies to various questionnaires, and the like. The cooking behavior video may be a video that records cooking of each user from the side in any kitchen including a home kitchen of the user. The cooking behavior video may be taken by the terminal device 100.

The model database 206b stores various machine learning models. The model database 206b may store a posture recognition model in which hand video frames in which a plurality of hand movements during cooking are recorded are training data, video frames that constitute the cooking behavior video are input, and a hand region is output. The model database 206b may store an object recognition model in which cooking utensil video frames in which a plurality of cooking utensils are recorded are training data, video frames that constitute the cooking behavior video are input, and a cooking utensil region is output.

The model database 206b may store a cooking motion estimation model that is a machine learning model in which a cooking video labeled with the hand region is training data, the hand region and the cooking utensil region are explanatory variables, and a cooking motion is a response variable.

The cooking database 206c stores cooking data. The cooking database 206c may store any one, some, or all of order data, cooking behavior data, posture recognition technology data, hand region data, object recognition technology data, cooking utensil region data, cooking motion data, cooking motion classification, cooking time, workload, cooking time representative value, workload representative value, outliers, and the like.

The control unit 202 is a CPU or the like that overall controls the cooking motion estimation device 200. The control unit 202 has an internal memory for storing a control program such as an OS, a computer program that defines various processing procedures, required data, and the like, and executes various information processing based on these stored programs. The control unit 202 functionally and conceptually includes a hand estimating unit 202a, a cooking utensil identifying unit 202b, a cooking motion estimating unit 202c, a time setting unit 202d, a classification calculating unit 202e, a cooking behavior obtaining unit 202f, a representative value obtaining unit 202g, an outlier identifying unit 202h, a food ingredient identifying unit 2021, and a seasoning identifying unit 202j.

The hand estimating unit 202a identifies the coordinates of a joint point and estimates a hand region that is a coordinate region of a hand, for each of video frames that constitute the cooking behavior video. The hand estimating unit 202a may identify the coordinates of a joint point and estimate a hand region that is a coordinate region of a hand, for each of video frames that constitute the cooking behavior video, based on posture recognition technology. The hand estimating unit 202a may identify the coordinates of a joint point and estimate a hand region that is a coordinate region of a hand, for each of video frames that constitute the cooking behavior video, using the posture recognition model.

The cooking utensil identifying unit 202b identifies a cooking utensil region that is a coordinate region of a cooking utensil, for each of the video frames that constitute the cooking behavior video. The cooking utensil identifying unit 202b may identify a cooking utensil region that is a coordinate region of a cooking utensil, for each of the video frames that constitute the cooking behavior video, based on object recognition technology. The cooking utensil identifying unit 202b may identify a cooking utensil region that is the coordinate region of the cooking utensil, for each of the video frames that constitute the cooking behavior video, using the object recognition model. The cooking utensil identifying unit 202b may identify the type of cooking utensil.

The cooking motion estimating unit 202c estimates a cooking motion for each of the video frames from the type of cooking utensil. When the hand region and the cooking utensil region overlap, the cooking motion estimating unit 202c may estimate a cooking motion for each of the video frames from the type of cooking utensil.

When the hand region and the cooking utensil region overlap, the cooking motion estimating unit 202c may estimate a cooking motion for each of the video frames from the type of cooking utensil, using the cooking motion estimation model. When the hand region and a food ingredient region overlap, or when the cooking utensil region and a food ingredient region overlap, the cooking motion estimating unit 202c may estimate a cooking motion for each of the video frames from the type of food ingredient. When the hand region and a seasoning region overlap, the cooking motion estimating unit 202c may estimate a cooking motion for each of the video frames from the type of seasoning.

The time setting unit 202d sets the video frames in connection with an elapsed time. The time setting unit 202d may obtain order data of the cooking motion, based on the cooking motion for each of the video frames.

The classification calculating unit 202e calculates a cooking time and a workload for each cooking motion classification that distinguishes a feature of the cooking motion. The classification calculating unit 202e may calculate a cooking time and a workload for each cooking motion classification that distinguishes a feature of the cooking motion, based on the cooking motion for each of the video frames. The classification calculating unit 202e may calculate a cooking time and a workload for each attribute and for each cooking motion classification, based on attribute data and the cooking motion for each of the video frames.

The cooking behavior obtaining unit 202f obtains cooking behavior data of the user. The cooking behavior obtaining unit 202f may obtain cooking behavior data of the user, based on the cooking time and the workload for each cooking motion classification, and the order data. The cooking behavior obtaining unit 202f may output (display) the cooking behavior data.

The representative value obtaining unit 202g obtains a cooking time representative value and a workload representative value for each cooking motion classification. The representative value obtaining unit 202g may obtain a cooking time representative value and a workload representative value for each cooking motion classification, based on the cooking time and the workload for each cooking motion classification of all of the users. The representative value may be a mean, a median, or the like.

The outlier identifying unit 202h identifies a cooking behavior video in which the cooking motion with any one or both of the cooking time and the workload that are outliers is recorded. The outlier identifying unit 202h may identify the cooking behavior video in which the cooking motion with any one or both of the cooking time and the workload that are outliers is recorded, based on any one or both of the cooking time representative value and the workload representative value.

The food ingredient identifying unit 2021 identifies a food ingredient region that is a coordinate region of a food ingredient, for each of the video frames that constitute the cooking behavior video. The food ingredient identifying unit 202i may identify a food ingredient region that is a coordinate region of a food ingredient, for each of the video frames that constitute the cooking behavior video, based on object recognition technology or image segmentation technology for video frames. The food ingredient identifying unit 202i may estimate intake nutrients from the food ingredient.

The seasoning identifying unit 202j identifies a seasoning region that is a coordinate region of a seasoning, for each of the video frames that constitute the cooking behavior video. The seasoning identifying unit 202j may identify a seasoning region that is a coordinate region of a seasoning, for each of the video frames that constitute the cooking behavior video, based on object recognition technology.

### 3. Cooking Motion Estimation Process

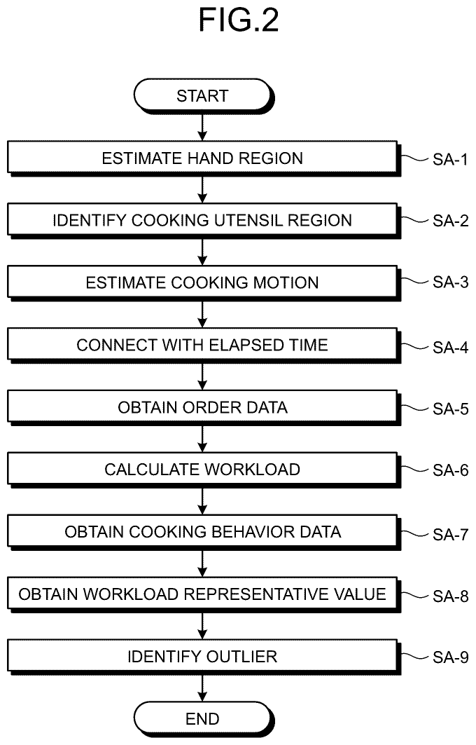

An example of a cooking motion estimation process according to the present embodiment will be explained with reference to FIG. 2 to FIG. 12. FIG. 2 is a flowchart of an example of the cooking motion estimation process according to the present embodiment.

As shown in FIG. 2, the hand estimating unit 202a of the cooking motion estimation device 200 identifies the coordinates of a joint point and estimates a hand region that is a coordinate region of a hand, for each of video frames that constitute the cooking behavior video of each user stored in the video database 206a, based on posture recognition technology (step SA-1).

The cooking utensil identifying unit 202b of the cooking motion estimation device 200 identifies a cooking utensil region that is a coordinate region of a cooking utensil, and the type of cooking utensil, for each of the video frames that constitute the cooking behavior video of each user stored in the video database 206a, based on object recognition technology (step SA-2).

When the hand region and the cooking utensil region overlap, the cooking motion estimating unit 202c of the cooking motion estimation device 200 estimates a cooking motion for each of the video frames from the type of cooking utensil (step SA-3).

The time setting unit 202d of the cooking motion estimation device 200 sets the video frames in connection with an elapsed time (step SA-4).

The time setting unit 202d of the cooking motion estimation device 200 obtains order data of the cooking motion, based on the cooking motion for each of the video frames (step SA-5).

The classification calculating unit 202e of the cooking motion estimation device 200 calculates a cooking time and a workload for each cooking proficiency level and for each cooking motion classification, based on the attribute data and the cooking motion for each of the video frames (step SA-6).

The cooking behavior obtaining unit 202f of the cooking motion estimation device 200 obtains cooking behavior data of the user, based on the cooking time and the workload for each cooking motion classification and the order data, and displays the cooking behavior data on the input/output unit 212 (step SA-7).

The representative value obtaining unit 202g of the cooking motion estimation device 200 obtains a cooking time representative value and a workload representative value for each cooking motion classification, based on the cooking time and the workload for each cooking motion classification of all of the users (step SA-8).

The outlier identifying unit 202h of the cooking motion estimation device 200 identifies the cooking behavior video in which the cooking motion with any one or both of the cooking time and the workload that are outliers is recorded, based on any one or both of the cooking time representative value and the workload representative value (step SA-9), and the processing is ended.

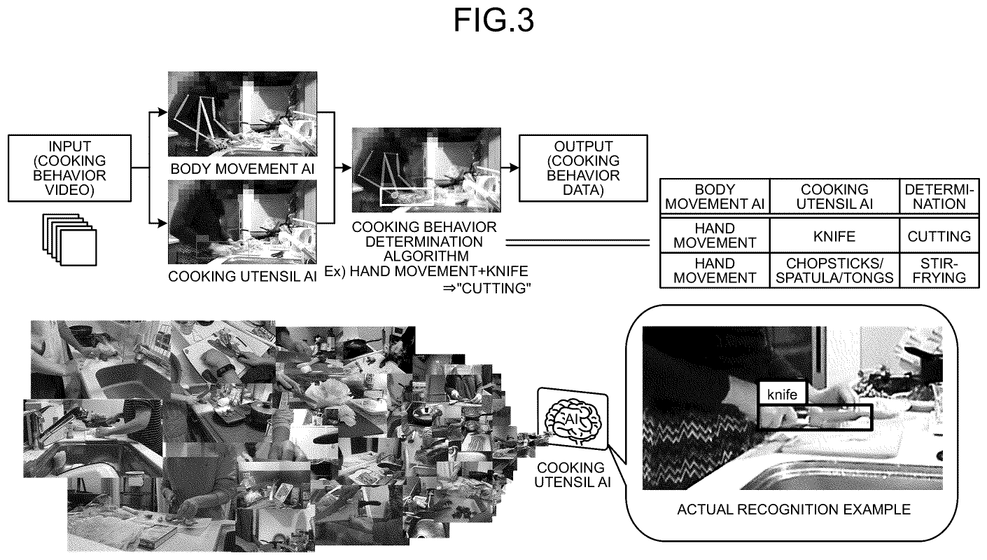

Referring now to FIG. 3 to FIG. 7, a specific example of the cooking motion estimation process according to the present embodiment will be explained. FIG. 3 to FIG. 7 are diagrams of an example of the cooking motion estimation process according to the present embodiment.

As shown in FIG. 3, in behavior analysis of home use test (HUT) cooking videos according to the present embodiment, “cooking utensils used (by users)” is adopted as a common criterion even under varying image capturing conditions. For example, a user is considered as performing a “cutting” behavior if “hand movement” and “knife” overlap, and a user is considered as performing a “stir-frying” if “chopsticks” or “spatula” and “tongs” overlap. A cooking behavior determination algorithm according to the present embodiment requires “cooking utensil AI” that recognizes cooking utensils, in addition to “body movement AI”. For the “cooking utensil AI”, since it is difficult for conventional AI to properly recognize cooking utensils, the present embodiment enables recognition of cooking utensils, as shown in FIG. 3, by creating more than 20,000 datasets from cooking videos and training the AI. According to the present embodiment, two cooking behaviors, namely, “cutting” and “stir-frying” can be identified, and in addition, more detailed cooking behaviors such as “holding a product” and “washing the dishes” can be identified by training the AI with product packages, faucets, and the like.

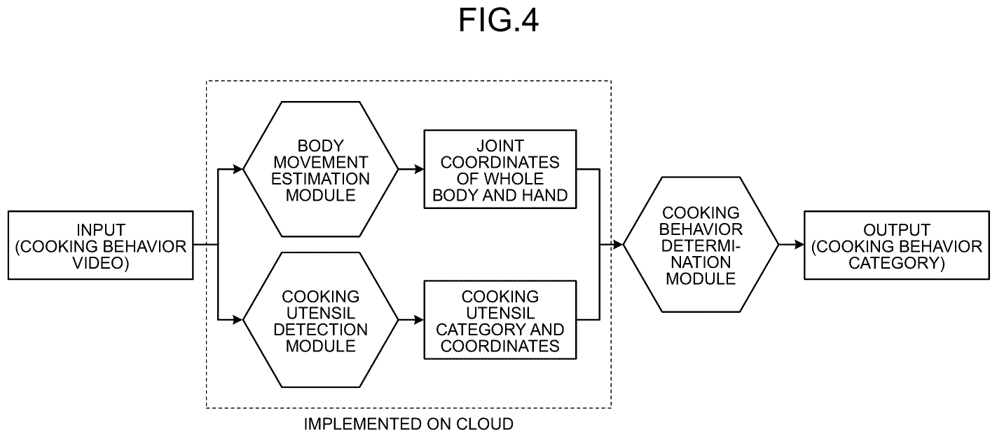

As shown in FIG. 4, according to the present embodiment, processing is performed that uses the cooking behavior video as input, identifies joint coordinates of the whole body and hand by a body motion estimation module using AI, identifies a category and coordinates of a cooking utensil by a cooking utensil detection module using AI, and outputs a cooking behavior category using a cooking behavior determination module.

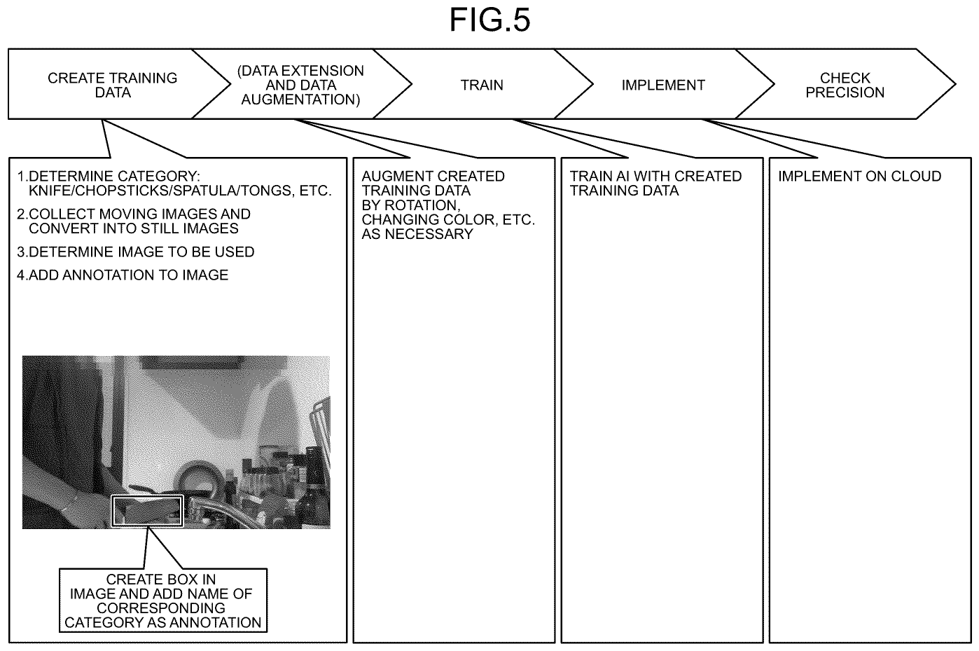

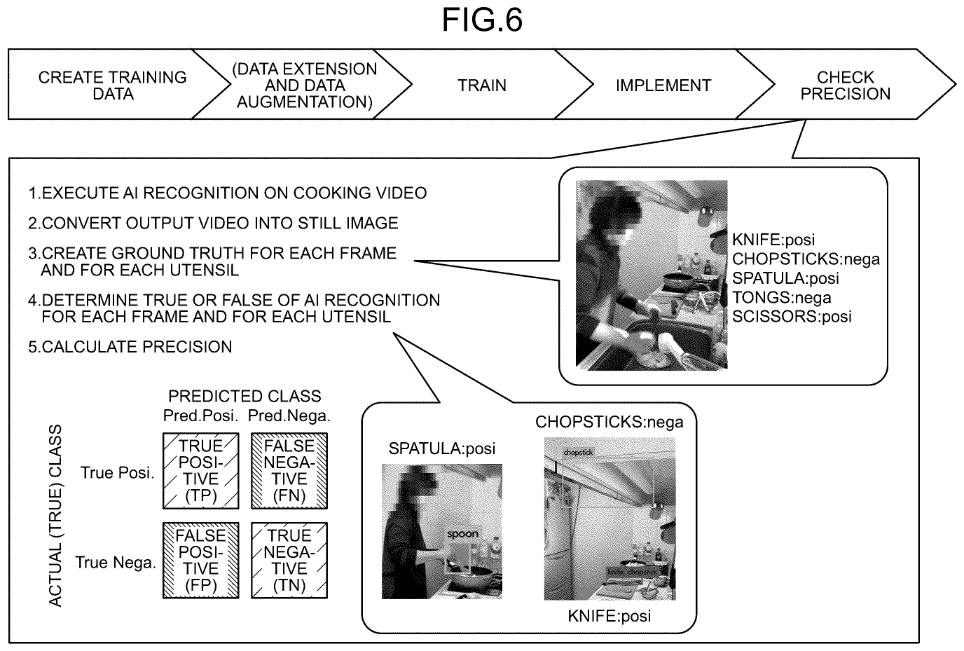

As shown in FIG. 5 and FIG. 6, according to the present embodiment, cooking utensil images in which a plurality of cooking utensils such as knives, chopsticks, spatulas, tongs, and scissors are recorded are created as training data, and an object recognition model that is a machine learning model that outputs a cooking utensil region is constructed. As shown in FIG. 6, the Benjamini-Hochberg method or the like using the False Discovery Rate may be performed as precision calculation according to the present embodiment.

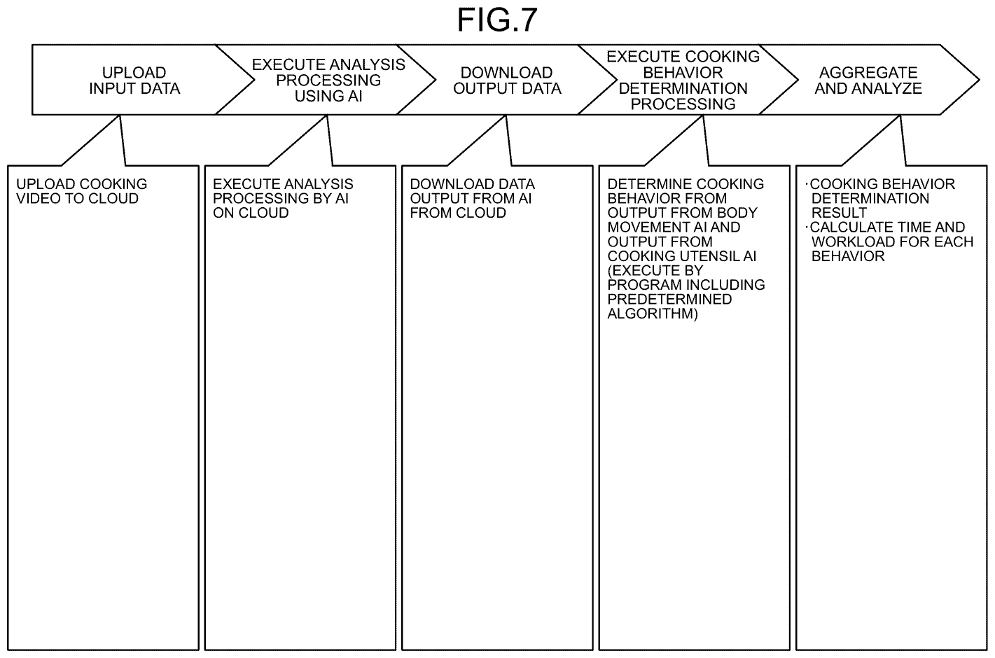

As shown in FIG. 7, according to the present embodiment, as a specific operation of the cooking motion estimation process, the collected cooking videos are uploaded to the cloud, and then AI analysis is executed, whereby an output result is output to the cloud. For the output data, a cooking behavior is determined by a predetermined algorithm. According to the present embodiment, the cooking behavior determination process may be executed using not only a cooking video in a HUT in each user's home kitchen but also a cooking video in a central location test (CLT) in a kitchen with the same standard.

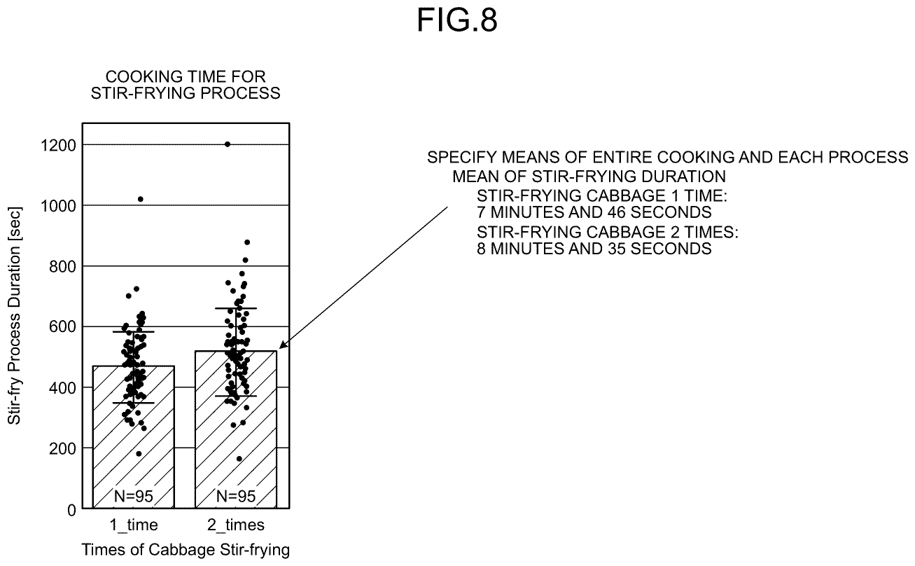

Referring to FIG. 8 to FIG. 10, an example of a cooking behavior analysis result according to the present embodiment will be explained. FIG. 8 to FIG. 10 are diagrams of an example of the cooking behavior analysis result according to the present embodiment.

As shown in FIG. 8, according to the present embodiment, for quantification of cooking behavior of twice-cooked pork cooking with stir-frying cabbage in two separate batches and twice-cooked pork cooking with stir-frying cabbage collectively in one batch, attention is focused on two behaviors, namely, “cutting” and “stir-frying”, and the cooking time and the workload of these behaviors are quantified. As shown in FIG. 8, according to the present embodiment, from home cooking of about 100 people, the mean of the cooking time for a stir-frying process is calculated to be about 7 minutes and 45 seconds for stir-frying cabbage one time and about 8.5 minutes for stir-frying cabbage two times. In this way, according to the present embodiment, the average cooking behavior pattern of people can be grasped numerically.

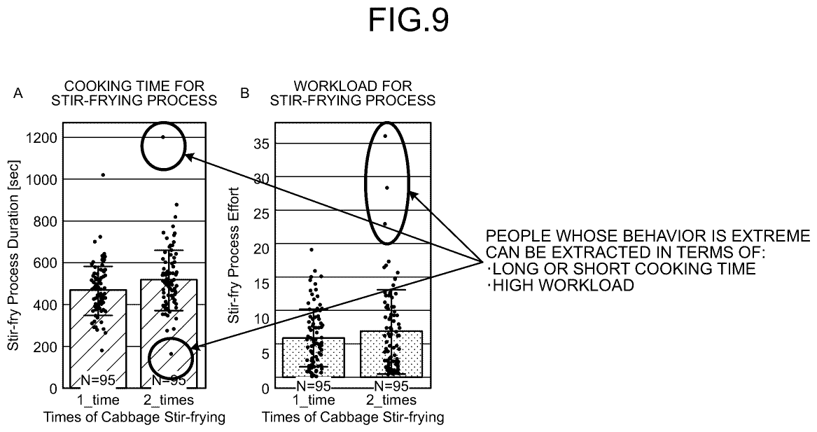

As shown in FIG. 9, according to the present embodiment, analysis of outliers makes it possible to confirm a behavior that becomes an issue of the cooking behavior of twice-cooked pork cooking with frying cabbage in two separate batches and twice-cooked pork cooking with frying cabbage collectively in one batch. In other words, as shown in FIG. 9, according to the present embodiment, (videos of) people whose behavior is extreme are extracted, so that the behavior of these people can be confirmed. FIG. 9 is a diagram of the results for the cooking time of the stir-frying process and the workload of the stir-frying process, in which the means are depicted by bars and raw data of each individual is plotted at each point. Thus, according to the present embodiment, five people, namely, the person with the longest cooking time and the person with the shortest cooking time in stir-frying two times, and the top three with a high workload are identified as outliers. According to the present embodiment, for the three people with a high workload, it is confirmed that they are moving the food ingredients for most of the time during stir-frying. This can be presumed to be the behavior of the three people with a high workload for fear that the food ingredients get burnt. According to the present embodiment, for the person with the longest stir-frying duration, it is confirmed that the finished cabbage and peppers are soft. This makes it possible to estimate that the end point of the stir-frying is difficult to find or that a soft finish is preferred.

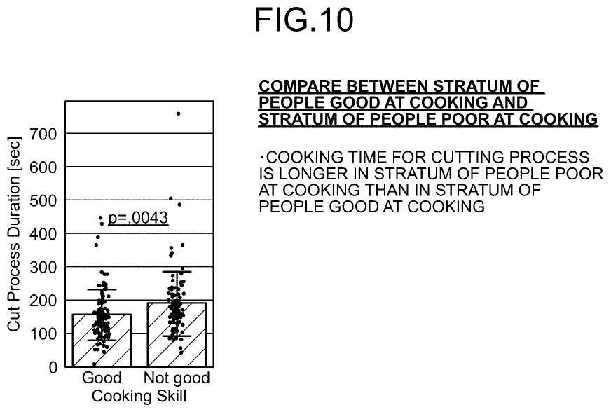

As shown in FIG. 10, according to the present embodiment, stratified analysis of cooking time is performed between a stratum of people good at cooking and a stratum of people poor at cooking, and the comparison result is obtained. As shown in FIG. 10, according to the present embodiment, the stratum of people good at cooking and the stratum of people poor at cooking are compared for the stir-frying process, and it can be confirmed that the cooking time for a cutting process is significantly longer in the stratum of people poor at cooking. In this way, according to the present embodiment, increasing the number of subjects enables stratified analysis by demographics or the like and enables extraction of a cooking issue from a new angle.

According to the present embodiment, in cooking motion estimation, machine learning may be used for estimation using a feature vector as input in which features for each frame are arrayed in chronological order. As a method of machine learning, training may be performed without using time information of the input feature vector, or training may be performed using a time-series model using time information. In either case, a model that regresses to a cooking motion estimation category in the output layer may be trained, or a model that makes a binary determination as to whether a motion is the motion of interest may be trained for each cooking motion estimation category. A deep learning model such as a support vector machine (SVM), a convolutional neural network, or a transformer can be used as the model without using time information. A deep learning model such as long short-term memory (LSTM) or a transformer can be used as the model using time information. As training data, data of cooking videos uniquely obtained and labeled with ground truth by humans may be used.

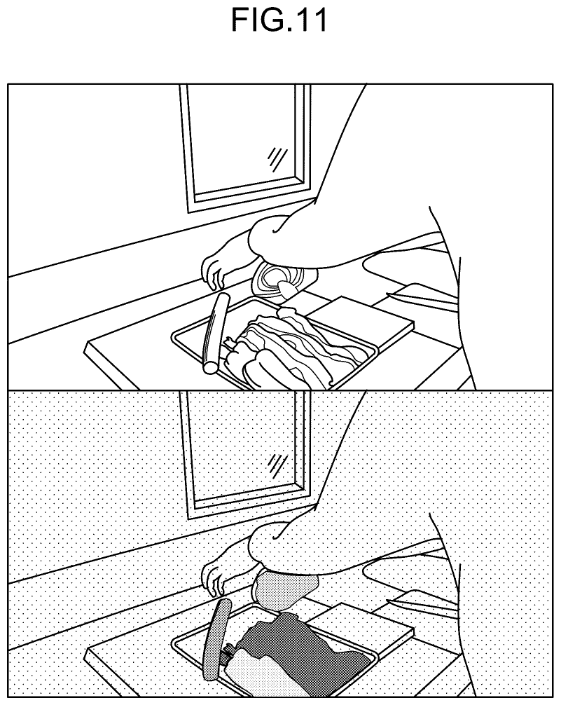

Referring to FIG. 6 and FIG. 11, an example of a food ingredient distinguishing process according to the present embodiment will be explained. FIG. 11 is a diagram of an example of image segmentation according to the present embodiment.

According to the present embodiment, food ingredients are recognized using any one method of an algorithm of object detection similar to the cooking utensil identification shown in FIG. 6 and an algorithm of semantic segmentation shown in FIG. 11, or using a combination of the two methods, and the nutrients ingested are estimated, whereby nutrients (groups) that are likely to be deficient may be identified and used to encourage users to ingest the identified nutrients (groups). According to the present embodiment, food ingredients are recognized mainly by their appearance (for example, shape, size, color), and the food ingredients to be used are recognized, whereby how much of what nutrients can be ingested in the meal completed by cooking can be estimated.

According to the present embodiment, seasonings are recognized using an algorithm similar to the cooking utensil identification, whereby a cooking motion can be estimated in more detail. In this way, according to the present embodiment, food ingredients and seasonings other than cooking utensils are recognized by object detection (object recognition) technology, whereby a cooking motion can be estimated in more detailed classification than when only cooking utensils are used. According to the present embodiment, seasonings are recognized mainly by their appearance (for example, shape, size, color). According to the present embodiment, object detection technology and optical character reader (OCR) are combined to separately recognize seasonings with similar appearance (for example, sugar and salt are separately recognized from the characters on their containers, and varieties are separately recognized from a group of products of the same brand). According to the present embodiment, a cooking motion is estimated in detailed classification to enable quantitative analysis of the time and effort for each motion, so that cooking behavior can be grasped and considered in a more concrete manner. For example, according to the present embodiment, the user's cooking skill and the time and effort required to cook a similar recipe are estimated from the quantitative analysis of the time and effort for each motion in cooking of a certain recipe, and can be utilized to recommend recipes and cooking processes (for example, whether to use gas or IH or whether to use a microwave oven, as a heating method) that match the user's cooking skill and psychology on cooking (time and effort desired, as well as awareness of sustainability such as energy and cost desired).

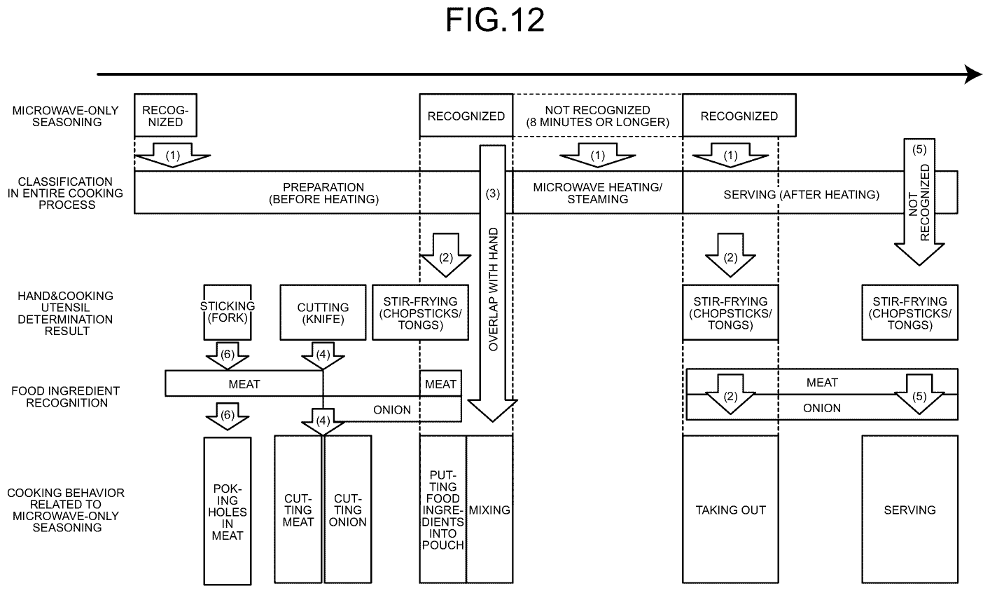

FIG. 12 is a diagram of an example of an analysis process of cooking behavior using a microwave-only seasoning according to the present embodiment. FIG. 12 is a diagram of an example of a cooking behavior analysis process according to the present embodiment.

As shown in FIG. 12, according to the present embodiment, (1) in the entire operation, a time period during which the microwave-only seasoning is recognized, a time period during which it is not recognized for 8 minutes or longer, and a time period after it is recognized again are determined as three processes, namely, “preparation (before heating)”, “microwave heating/steaming”, and “serving (after heating)”, respectively. (2) In a time period during which a region of hand, a region of microwave-only seasoning, and a region of chopsticks or tongs are recognized in an overlapping manner, the time period determined as “preparation (before heating)” is determined as “putting food ingredients into pouch”, and the time period determined as “serving (after heating)” is determined as “taking out”. (3) After the time period determined as “putting food ingredients into pouch”, a time period during which the region of microwave-only seasoning and the region of hand overlap and which is determined as “preparation (before heating)” is determined as “mixing”. (4) A time period determined as “cutting” is determined separately as “cutting onion” or “cutting meat” according to a region of food ingredient recognized in an overlapping manner with the region of knife. (5) A time period during which the region of hand and the region of chopsticks or tongs are recognized in an overlapping manner but the region of hand and the region of microwave-only seasoning do not overlap, and which is determined as “serving (after heating)” is determined as “serving”. (6) A time period during which the region of hand and a region of fork are recognized in an overlapping manner and during which meat is recognized in an overlapping manner with the region of hand and the region of fork is determined as “poking holes in meat”.

### 4. Other Embodiments

In addition to the embodiment described above, the present invention may be implemented in a variety of different embodiments within the scope of the technical concepts recited in the claims.

For example, among the processes explained in the embodiment, all or one or some of the processes explained as being performed automatically can be performed manually, or all or one or some of the processes explained as being performed manually can be performed automatically in a known manner.

The processing procedures, control procedures, specific names, information including parameters such as registration data in each process and search conditions, screen examples, and database configurations provided in the present description and in the drawings may be modified as desired unless otherwise specified.

Each of the components illustrated in the drawings for the terminal device 100, the cooking motion estimation device 200, and the like is functional and conceptual and is not necessarily physically configured as illustrated in the drawings.

For example, all or any one or more of the processing functions of the terminal device 100, the cooking motion estimation device 200, and the like, especially each processing function performed by the control unit, may be implemented by a CPU and a computer program interpreted and executed by the CPU, or may be implemented as hardware using wired logic. The computer program is recorded on a non-transitory tangible computer-readable recording medium containing programmed instructions for causing an information processing device to perform the processes explained in the present embodiment, and is mechanically read by the terminal device 100 as needed. In other words, a computer program for giving instructions to a CPU to perform various processing in cooperation with an OS is recorded in a storage unit such as a ROM or a hard disk drive (HDD). The computer program is executed by being loaded into a RAM to configure the control unit in cooperation with a CPU.

The computer program may be stored in an application program server connected via any network 300 to the terminal device 100, the cooking motion estimation device 200, and the like, or may be downloaded entirely or partially as needed.

The computer program for executing the processes explained in the present embodiment may be stored in a non-transitory tangible computer-readable recording medium or may be configured as a program product. The “recording medium” includes any “portable physical medium” such as memory card, universal serial bus (USB) memory, secure digital (SD) card, flexible disk, magneto-optical disk, ROM, erasable programmable read only memory (EPROM), electrically erasable and programmable read only memory (EEPROM (registered trademark)), compact disc read only memory (CD-ROM), magneto optical disk (MO), digital versatile disc (DVD), and Blu-ray (registered trademark) disc.

The “computer program” is a data processing method written in any language or description method, and can be in any format such as source code or binary code. The “computer program” is not necessarily limited to those configured singly, but includes those configured in a distributed manner as multiple modules or libraries, and those that cooperate with separate programs, such as an OS, to achieve their functions. Well-known configurations and procedures can be used for a specific configuration and a reading procedure for reading a recording medium in each of the devices described in the present embodiment, as well as for an installation procedure after reading.

Various databases and the like stored in the storage unit are memory devices such as a RAM and a ROM, fixed disk devices such as hard disks, flexible disks, and storage means such as optical disks, and store various programs, tables, databases, web page files, and the like to be used for various processes and website provision.

The terminal device 100, the cooking motion estimation device 200, and the like may be configured as an information processing device such as a known personal computer or workstation, or may be configured as the information processing device to which any peripheral devices are connected. The terminal device 100, the cooking motion estimation device 200, and the like may be implemented by implementing software (including a computer program or data and the like) that causes the devices to perform the processes explained in the present embodiment.

The specific form of distribution and integration of the devices is not limited to that illustrated in the drawings, but the devices can be functionally or physically distributed and integrated entirely or partially in any units according to various additions or according to functional load. In other words, any combination of the foregoing embodiments may be implemented, or the embodiments may be implemented selectively.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A cooking motion estimation device comprising a storage unit and a control unit, wherein
the storage unit includes:
a video storage unit that stores a cooking behavior video of each of users, and
the control unit includes:
a hand estimating unit that identifies coordinates of a joint point and estimates a hand region that is a coordinate region of a hand, for each of video frames that constitute the cooking behavior video, based on posture recognition technology;
a cooking utensil identifying unit that identifies a cooking utensil region that is a coordinate region of a cooking utensil, for each of the video frames that constitute the cooking behavior video, based on object recognition technology; and
a cooking motion estimating unit that estimates a cooking motion for each of the video frames from a type of the cooking utensil when the hand region and the cooking utensil region overlap.

2. The cooking motion estimation device according to claim 1, wherein
the control unit further includes:
a time setting unit that sets the video frames in connection with an elapsed time; and
a classification calculating unit that calculates a cooking time and a workload for each cooking motion classification that distinguishes a feature of the cooking motion, based on the cooking motion for each of the video frames.

3. The cooking motion estimation device according to claim 2, wherein
the control unit further includes:
a representative value obtaining unit that obtains a cooking time representative value and a workload representative value for the each cooking motion classification, based on the cooking time and the workload for the each cooking motion classification of all of the users.

4. The cooking motion estimation device according to claim 3, wherein
the control unit further includes:
an outlier identifying unit that identifies the cooking behavior video in which the cooking motion with any one or both of the cooking time and the workload that are outliers is recorded, based on any one or both of the cooking time representative value and the workload representative value.

5. The cooking motion estimation device according to claim 2, wherein
the cooking behavior video is set in connection with attribute data indicating an attribute of the user, and
the classification calculating unit calculates the cooking time and the workload for each attribute and for the each cooking motion classification, based on the attribute data and the cooking motion for each of the video frames.

6. The cooking motion estimation device according to claim 2, wherein
the time setting unit further obtains order data of the cooking motion, based on the cooking motion for each of the video frames, and
the control unit further includes:
a cooking behavior obtaining unit that obtains cooking behavior data of the user, based on the cooking time and the workload for the each cooking motion classification, and the order data.

7. The cooking motion estimation device according to claim 1, wherein
the storage unit further includes:
a model storage unit that stores a posture recognition model in which hand video frames in which a plurality of hand movements during cooking are recorded are training data, the video frames that constitute the cooking behavior video are input, and the hand region is output, and
the hand estimating unit identifies the coordinates of a joint point and estimates the hand region that is the coordinate region of a hand, for each of the video frames that constitute the cooking behavior video, using the posture recognition model.

8. The cooking motion estimation device according to claim 1, wherein
the storage unit further includes:
a model storage unit that stores an object recognition model in which cooking utensil video frames in which a plurality of the cooking utensils are recorded are training data, the video frames that constitute the cooking behavior video are input, and the cooking utensil region is output, and
the cooking utensil identifying unit identifies the cooking utensil region that is the coordinate region of the cooking utensil, for each of the video frames that constitute the cooking behavior video, using the object recognition model.

9. The cooking motion estimation device according to claim 5, wherein the attribute is a cooking proficiency level for distinguishing between being good at cooking and being poor at cooking.

10. The cooking motion estimation device according to claim 1, wherein the cooking behavior video is a video that records cooking of each of the users from a side in any kitchen including a home kitchen of the user.

11. The cooking motion estimation device according to claim 1, wherein
the storage unit further includes:
a model storage unit that stores a cooking motion estimation model that is a machine learning model in which a cooking video labeled with the hand region is training data, the hand region and the cooking utensil region are explanatory variables, and the cooking motion is a response variable, and
when the hand region and the cooking utensil region overlap, the cooking motion estimating unit estimates the cooking motion for each of the video frames from a type of the cooking utensil, using the cooking motion estimation model.

12. The cooking motion estimation device according to claim 1, wherein the control unit further includes:
a food ingredient identifying unit that identifies a food ingredient region that is a coordinate region of a food ingredient, for each of the video frames that constitute the cooking behavior video, based on the object recognition technology or image segmentation technology for the video frames.

13. The cooking motion estimation device according to claim 12, wherein the food ingredient identifying unit further estimates intake nutrients from the food ingredient.

14. The cooking motion estimation device according to claim 12, wherein when the hand region and the food ingredient region overlap, or when the cooking utensil region and the food ingredient region overlap, the cooking motion estimating unit further estimates the cooking motion for each of the video frames from a type of the food ingredient.

15. The cooking motion estimation device according to claim 1, wherein the control unit further includes:
a seasoning identifying unit that identifies a seasoning region that is a coordinate region of a seasoning, for each of the video frames that constitute the cooking behavior video, based on the object recognition technology.

16. The cooking motion estimation device according to claim 15, wherein when the hand region and the seasoning region overlap, the cooking motion estimating unit further estimates the cooking motion for each of the video frames from a type of the seasoning.

17. A cooking motion estimation method executed by a cooking motion estimation device including a storage unit and a control unit, wherein
the storage unit includes:
a video storage unit that stores a cooking behavior video of each of users,
the cooking motion estimation method executed by the control unit comprising:
a hand estimating step of identifying coordinates of a joint point and estimating a hand region that is a coordinate region of a hand, for each of video frames that constitute the cooking behavior video, based on posture recognition technology;
a cooking utensil identifying step of identifying a cooking utensil region that is a coordinate region of a cooking utensil, for each of the video frames that constitute the cooking behavior video, based on object recognition technology; and
a cooking motion estimating step of, when the hand region and the cooking utensil region overlap, estimating a cooking motion for each of the video frames from a type of the cooking utensil.

18. A cooking motion estimation program executed by a cooking motion estimation device including a storage unit and a control unit, wherein
the storage unit includes:
a video storage unit that stores a cooking behavior video of each of users,
the cooking motion estimation program causing the control unit to execute:
a hand estimating step of identifying coordinates of a joint point and estimating a hand region that is a coordinate region of a hand, for each of video frames that constitute the cooking behavior video, based on posture recognition technology;
a cooking utensil identifying step of identifying a cooking utensil region that is a coordinate region of a cooking utensil, for each of the video frames that constitute the cooking behavior video, based on object recognition technology; and
a cooking motion estimating step of, when the hand region and the cooking utensil region overlap, estimating a cooking motion for each of the video frames from a type of the cooking utensil.
